(19) United States
(12) Patent Application Publication
(10) Pub. No.: US 2013/0100008 A1
(43) Pub. Date: Apr. 25, 2013

(54) Haptic Response Module

(71) Applicants: Stefan J. Marti, Santa Clara, CA (US); Seung Wook Kim, Cupertino, CA (US); Eric Liu, Santa Clara, CA (US)

(72) Inventors: Stefan J. Marti, Santa Clara, CA (US); Seung Wook Kim, Cupertino, CA (US); Eric Liu, Santa Clara, CA (US)

(21) Appl. No.: 13/276,564

(22) Filed: Oct. 19, 2011

(51) Int. Cl. G09G 5/00

(52) U.S. Cl. 345/156

(57) ABSTRACT

Embodiments provide an apparatus that includes a tracking sensor to track movement of a hand behind a display, such that a virtual object may be output via a display, and a haptic response module to output a stream of gas based a determination that the virtual object has interacted with a portion of the image.

### BACKGROUND

Various computing devices are capable of displaying images to a user. Once displayed, the user may manipulate the images in a variety of manners. For example, a user may utilize a peripheral such as a mouse or keyboard to alter one or more aspects of the image. In another example, a user may utilize their hands to alter one or more aspects of the image, either on the surface of a display or off the surface (remote manipulation). In the latter case, when utilizing their hands, various inconvenient and obtrusive peripherals such as gloves are utilized to provide feedback to the user.

### BRIEF DESCRIPTION OF THE DRAWINGS

FIG. 1 illustrates an example apparatus in accordance with an example of the present disclosure;

FIG. 2 illustrates a user in combination with an apparatus in accordance with an example of the present disclosure;

FIG. 3 is an elevational view of a user in combination with an apparatus in accordance with an example of the present disclosure;

FIG. 4 is an example of an apparatus in accordance with the present disclosure;

FIGS. 5-6 illustrate example flow diagrams; and

FIG. 7 is an example of apparatus incorporating a computer readable medium in accordance with the present disclosure.

### DETAILED DESCRIPTION

Computing devices such as laptop computers, desktop computers, mobile phones, smart phones, tablets, slates, and netbooks among others, are used to view images. The images may include a three-dimensional (3D) aspect in which depth is added to the image. A user of these devices may interact with the images utilizing video see-through technology or optical see-through technology.

Video and optical see-through technologies enable a user to interact with an image displayed on the device by reaching behind the device. A virtual image corresponding to the user's hand is displayed on the device, in addition to the image. In video see-through technology, a camera receives an image of the user's hand, which is then output on the display. In optical see-through technology, the display may be transparent enabling the user to view the image as well as their hand. In this manner, a user may interact with an image displayed on the device in the free space behind the device.

While a user is capable of interacting with an image via video or optical see-through technology, haptic feedback is not received because any manipulation of the image occurs virtually (i.e., on the display of the device). While gloves, such as vibro-tactile gloves, and other peripherals may be used to provide tactile feedback, they are inconvenient, obtrusive, and expensive.

In the present disclosure, a device utilizing a haptic response module is described. As used herein, a haptic response is a response that enables a user to sense or perceive touch. The haptic response may be achieved using a non-contact actuator such as a steerable air jet, where “air” may include various gases, for example oxygen, nitrogen, and carbon dioxide among others. In other words, the disclosure describes the use of an actuation device, a haptic response module, and a tracking sensor to provide a haptic response for a reach-behind-display device that allows natural, direct, and bare hand interaction with virtual objects and images.

FIG. 1 is an illustration of an apparatus 100. The apparatus 100 comprises a tracking sensor 102, an actuation device 104, and a haptic response module 106. The apparatus 100 may be utilized in conjunction with computing devices such as, but not limited to, desktop and laptop computers, netbooks, tablets, mobile phones, smart phones, and other computing devices which incorporate a screen to enable users to view images. The apparatus 100 may be coupled to the various computing devices, or alternatively, may be integrated into the various computing devices.

In the illustrated example, the apparatus 100 includes a tracking sensor 102. The tracking sensor 102 is to track movement of a hand (or other objects) behind a display. The tracking sensor 102 may be a general purpose camera disposed on a back side of the computing device (opposite a main display), a specialized camera designated solely for tracking purposes, an Infra-Red (IR) sensor, a thermal sensor, or an ultrasonic gesture detection sensor, among others. The tracking sensor 102 may provide video capabilities and enable tracked objects to be output via the display in real-time, for example, a gesture made by a hand. The tracking sensor 102 may utilize image differentiation of optic flow to detect and track hand movement. Consequently, in response to the tracking sensor 102 tracking movement or a gesture of a hand, the display is to output a virtual object that moves in accordance with the movement or gesture of the hand. The virtual object may be any object which represents the hand. For example, the virtual object may be an animated hand, an actual image of the hand, or any other object.

The haptic response module 106 is coupled to the tracking sensor 102 and is to output a stream of gas based on a determination that the virtual object has interacted with a portion of the image. A haptic response module 106 may comprise an air jet implemented as a nozzle that is ejecting compressed air from a compressor or air bottle, as a micro turbine, a piezo-actuated diaphragm, a micro-electromechanical system (MEMS) based turbine, a blower, or an array of blowers. The air flow may be enabled or disabled by a software controlled valve. The haptic response module 106 is to deliver a concentrated flow of air to a specific location. Because the distance between the device and the hand (i.e. the specific location) is generally small, in various examples less than approximately fifteen centimeters (15 cm), air diffusion is minimal such that the haptic response module 106 is capable of generating sufficient localized force. The relatively small distance also enables the haptic response module 106 to deliver pressure at an acceptable level thereby generating realistic feedback for a user.

The haptic response module 106 may be directed or aimed by an actuation device 104. The actuation device 104 is coupled to the haptic response module 106, and is to direct the haptic response module 106 toward the hand. The actuation device 104 may aim at the hand using information from the tracking sensor 102. The actuation device 104 may comprise a variety of technologies to direct the haptic response module 106. For example, the actuation device 104 may comprise micro servos, micro actuators, galvanometer scanners, ultrasonic motors, or shape memory alloy based actuators.

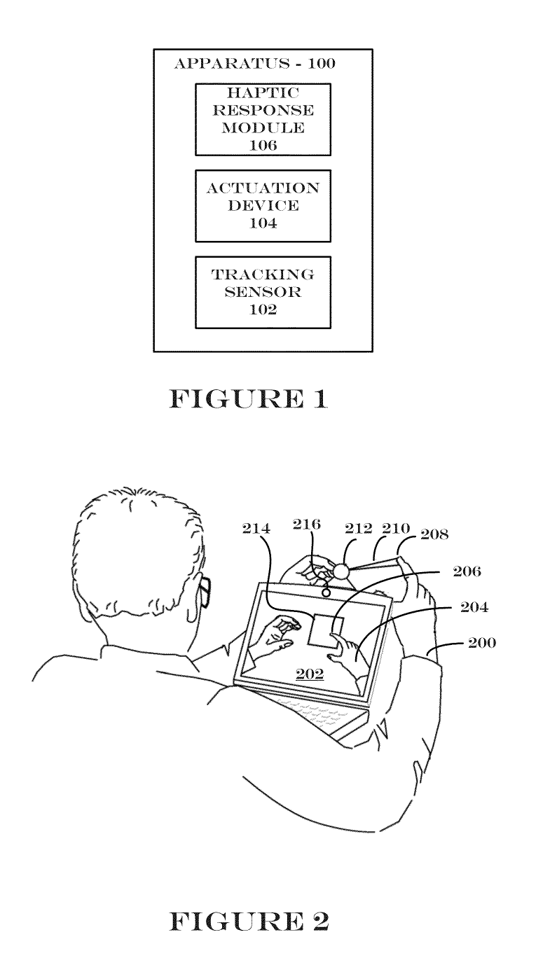

FIG. 2 is an illustration of a user manipulating an image displayed on a computing device with their hand and receiving haptic feedback. As illustrated, a user is disposed in front of a laptop computing device with their hands disposed behind a display 202. A sensor 212, for example a tracking sensor, is disposed on a back side of the computing device (i.e. a side facing away from a user). The user's hands or hand 200 is detected and a virtual object 204 is output via the display 202 of the computing device. The virtual object 204 may be an unaltered image of the user's hand as illustrated, a virtual representation of the user's hand, or other objects, which become part of the scene displayed by the computing device. The term “hand” as used herein may include, in addition to a users hand, fingers, and thumb, the user's wrist and forearm, all of which may be detected by the tracking sensor.

As a virtual object 204 associated with the user's hand 200 is output on the display 202 of the computing device, the user may interact with an image 214 that is also being displayed by the computing device. By viewing the virtual object 204, which mirrors the movements of the user's hand 200, a user may obtain visual coherence and interact with various objects 214 output via the display 202. Upon contact 206 or interaction with various objects or portions within the image, a haptic response module 212 may generate and output a stream of air 210. The stream of air 210 output by the haptic response module 212 may be directed to a location 208 of the user's hand 200 by an actuation device (not illustrated) that aims the haptic response module 212. It is noted that in the illustrated example, the haptic response module 212 is combined with the tracking sensor 212. In other examples, the two devices may be separate components.

The haptic response module 212 may output a stream of air 210, for example compressed air, for a predefined period of time. In one example, the haptic response module 212 may output a stream of air 210 for half of a second (0.5 sec) in response to a user tapping 206 an object 214 within an image (e.g., a button). In another example, the haptic response module 212 may output a stream of air 210 for one second (1 sec) in response to a user continually touching an item 206 within the image. Other lengths of time are contemplated. In addition to varying an amount of time a stream of air 210 is output, the haptic response module 212 may vary a pressure of the air stream 210. The pressure may vary dependent upon the depth of the object 214 interacted with in the image or the type of object interacted with by the user's hand.

In addition to the tracking sensor 212, haptic response module 212, and actuation device (not illustrated), the computing device may additionally include a facial tracking sensor 216. The facial tracking sensor 216 may be coupled to the tracking sensor 212 and is to track movement of a face relative to the display 202. The facial tracking sensor 216 may be utilized for in-line mediation. In-line mediation refers to the visually coherent and continuous alignment of the user's eyes, the content on the display, and the user's hands behind the display in real space. In-line mediation may be utilized in video see-through technologies. When utilizing a camera as a tracking sensor 212, the computing device may utilize a position of a user's eyes or face to determine a proper location for the virtual object 204 (La, the user's hand) on the display screen 202. This enables the computing device to rotate, tilt, or move while maintaining visual coherency.

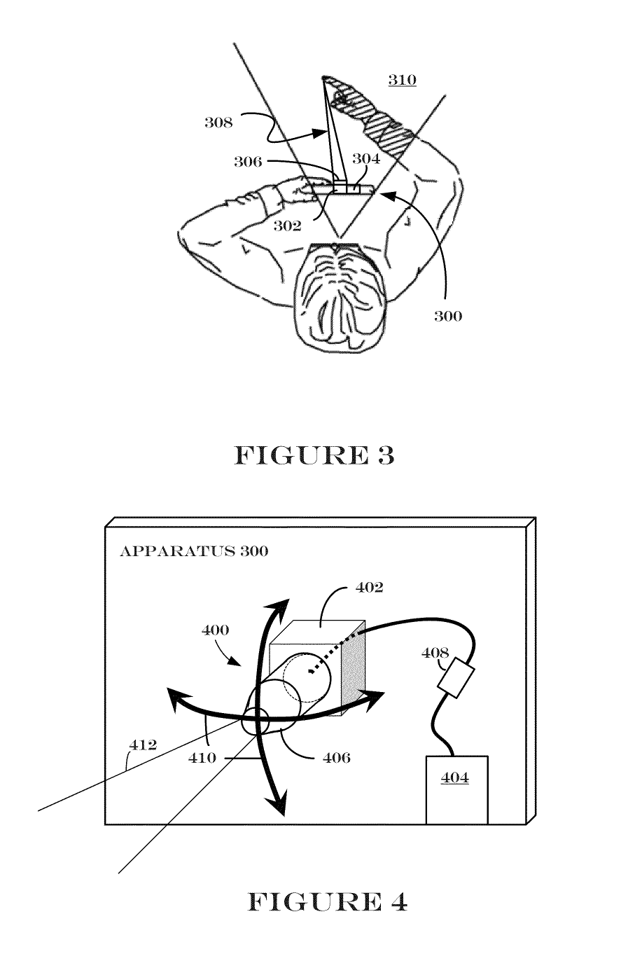

FIG. 3 is an elevated view illustrating in-line mediation and a device utilizing haptic feedback. The illustration shows a user holding a mobile device 300 with their left hand. The user extends their right hand behind the device 300. An area 310 behind the mobile device 300, indicated by angled lines, is an area in which tracking sensor 304 tracks movement of the user's hand. The user can move their right hand within area 310 to manipulate images or objects within images output via the display.

In response to the manipulation of the images or objects within the image, a haptic response module 306 may output a stream of gas 308 (e.g., compressed air) toward the user's hand. The stream of gas 308 may be sufficiently localized to a tip of the user's finger, or may be more generally directed at the user's hand. In order to direct the stream of gas toward the location of the user's hand, an actuation device 302 may direct the haptic response module 306 toward the location of the user's hand. The actuation device 302 may follow the hand tracked by the tracking sensor 304, or alternatively, may determine a location of the user's hand upon a determination that the virtual object (i.e., the virtual representation of the user's hand) has interacted with the image or a portion of the image.

Referring to FIG. 4, a perspective view of the apparatus 300 is illustrated in accordance with the present disclosure. The apparatus 300 includes a haptic response module 400, an actuation device 402, a blower 404, and a valve 408. The haptic response module 400 may include a nozzle 406 that is configured to pan and tilt in various directions 410. The nozzle 406 may have varying diameters dependent upon the intended stream of gas to be output.

In the illustrated embodiment, haptic response module 400 is coupled to an actuation device 402 and a blower or array of blowers 404. The actuation device 402, as stated previously, may comprise multiple forms including but not limited to various servos. The actuation device 402 is to direct the haptic response module 400 including nozzle 406 toward a location associated with a user's hand. The actuation device 402 may be software controlled for pan/tilting. In one embodiment, the actuation mechanism may comprise two hinges which may be actuated by two independently controller servos.

Once appropriately aimed, the blower or array of blowers 404 may output a stream of gas 412, such as compressed air to provide a haptic response. Control of the blowers may occur via an actuated valve 408. The valve 408 may be disposed along a length of tubing or other material that is utilized to provide the air to the haptic response module 400. It is noted that other forms may be utilized to provide a haptic response module that is capable of pan and tilt motions. For example, a blower may be embodied within the housing of the computing device and one or more fins may be utilized to direct the stream of gas 412. Other variations are contemplated.

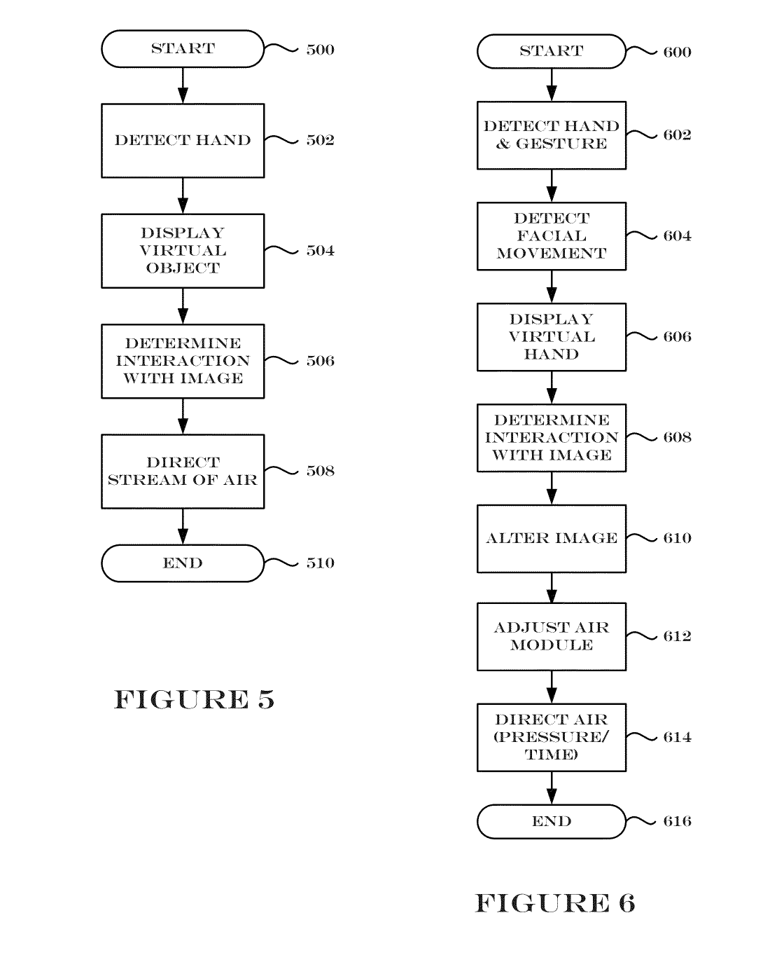

Referring to FIG. 5, a flow diagram is illustrated in accordance with an example of the present disclosure. The flow diagram may be implemented utilizing an apparatus as described with reference to the preceding figures. The process may begin at 500 where a user may power on the device or initiate an application stored on a computer readable medium in the form of programming instructions executable by a processor.

The process continues to 502 where the apparatus may detect a hand behind a display of the computing device. The computing device may detect the hand utilizing a tracking sensor, which in various examples may be integrated into the housing of the computing device, or alternatively, externally coupled to the computing device. The hand may be detected in various manners. For example, the tracking device may detect a skin tone of the user's hand, sense its temperature, scan the background for movement within a particular range of the device, or scan for high contrast areas. The tracking device may continually track the users hand such that is capable of conveying information to the computing device regarding the location of the hand, gestures made by the hand, and the shape of the hand (e.g., the relative position of a users fingers and thumb).

Based on, or in response to, detection of the hand, the computing device may display a virtual object via a display of the computing device at 504. In various examples, a user may see an unaltered representation of their hand, an animated hand, or another object. The display of the virtual object may be combined with the image displayed on the screen utilizing various techniques for combining video sources, such techniques related to overlaying and compositing.

As the user begins to move their hand either up, down, inward, outward (relative to the display), or by making gestures, the position of the hand may be described in terms of coordinates (e.g., x, y, and z). This tracking, when combined with an image having objects at various coordinates, enables the computing device to determine whether the hand has interacted with a portion of the image output via the display. In other words, when a coordinate of the hand has intersected a coordinate of an object identified within the image, the computing device may determine that a collision or interaction has occurred 506. This identification may be combined with a gesture such that the computing device may recognize that a user is grabbing, squeezing, poking, or otherwise manipulating the image.

In response to a determination that an interaction with the image has occurred, the computing device, via the actuation device, may direct a stream of air to a position of the hand to convey a haptic response 508. The method may then end at 510. Ending in various examples may include the continued detecting, displaying, tracking, and directing as described.

Referring to FIG. 6, another flow diagram is illustrated in accordance with an example of the present disclosure. The flow diagram may be implemented utilizing an apparatus as described with reference to the preceding figures. The process may begin at 600 where a user may power on the device or initiate an application stored on a computer readable medium in the form of programming instructions executable by a processor.

Similar to FIG. 5, the computing device may detect a hand and a gesture at 602. In various examples, a tracking sensor is utilized to detect the hand and track its movements and gestures. As the user starts moving their hand, the tracking sensor may track the movements and gestures which may include horizontal, vertical, and depth components. While detecting the hand and gesture at 602, the computing device may detect facial movement 604. A facial tracking sensor, for example, a camera facing the user, may track the user's face or portions of their face relative to the display. The facial tracking sensor may track a user's eyes relative to the display for the purposes of in-line mediation. As stated previously, in-line mediation facilitates the rendering of virtual objects on a display relative to a position of the user's eyes and the user's hand.

Based on the facial tracking and the tracking of the hand, the computing device may display a virtual hand at 606. In various examples, a user may see an unaltered representation of their hand, an animated hand, or another object. The display of the virtual hand may be combined with the image displayed on the screen utilizing various techniques for combining video sources, such techniques related to overlaying and compositing.

At 608, the computing device may determine whether the virtual hand has interacted with the image. The interaction may be based on a determination that a coordinate of the virtual hand has intersected a coordinate of an identified object within the image. Based on the interaction, which may be determined via the tracking sensor detecting a gesture of the hand, the computing device may alter an appearance of the image at 610. The alteration of the image at 610 may correspond to the gesture detected by the tracking sensor, for example, rotating, squeezing, poking, etc.

While altering image 610, computing device at 612 may adjust the haptic response module via an actuation device. The adjustment may include tracking of the user's hand while making the gestures, or repositioning the haptic response module in response to a determination of the interaction with the image. Once directed toward a location of the user's hand, the computing device may direct a stream of air to the location of the user's hand. In various examples, the length of time the air stream is present and/or the pressure associated with the air stream may be varied by the computing device. At 616, the method may end. Ending may include repeating one or more of the various processes described above.

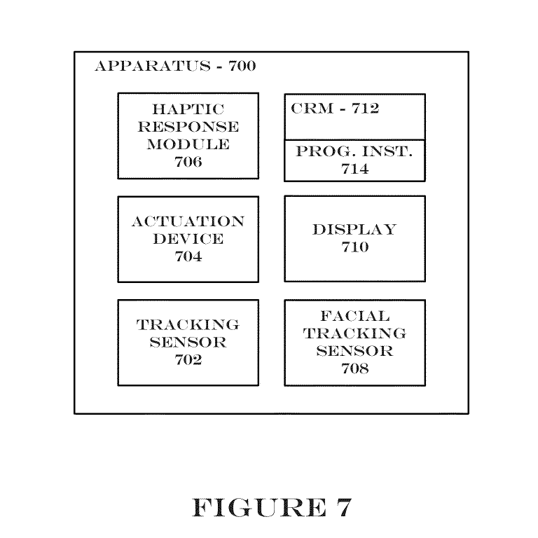

Referring to FIG. 7, another example of an apparatus is illustrated in accordance with an example of the present disclosure. The apparatus of FIG. 7 includes components generally similar to those described with reference to FIGS. 1-4, which unless indicated otherwise, may function as described with reference to the previous figures. More specifically, the apparatus 700 includes a tracking sensor 702, an actuation device 704, an haptic response module 706, a facial tracking sensor 708, a display 710, and a computer readable medium (CRM) 712, having programming instructions 714 stored thereon.

The programming instructions 714 may be executed by a processor (not illustrated) to enable the apparatus 700 to perform various operations. In one example, the programming instructions enable the apparatus 700 to display an image and a virtual representation of a hand on a display 710. The virtual representation of the hand may be based on a user's hand disposed behind the display 710, which is tracked by tracking sensor 702. Based on the tracking, the computing device may determine that the virtual representation of the hand has interacted with the image. As stated previously, this may be done by comparing coordinates of the virtual object and a portion of the image displayed on display 710 of the apparatus 700. In response to a determination that the image has been interacted with, the apparatus 700 may direct a stream of air to the hand of the user disposed behind the display to convey a haptic response. The apparatus may direct the stream of air by utilizing actuation device 704 to aim the air module 706.

In another example, the programming instructions 714 enable the apparatus 700 to detect facial movement of the user relative to the display 710. The apparatus may detect facial movement via a facial tracking sensor 708. The facial tracking sensor 708 enables the apparatus 700 to utilizing in-line mediation to display a a virtual representation of the hand on the display 710 and direct the stream of air to the hand of the user disposed behind the display 710. The stream of air directed to the hand of the user via actuation device 704 and air module 706 may vary in duration and may have a predetermined pressure.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. An apparatus, comprising:
a tracking sensor to track movement of a hand behind a display, wherein the display is to output a virtual object and an image, the virtual object moving in accordance with the movement of the hand;
a haptic response module coupled to the tracking sensor, wherein the haptic response module is to output a stream of gas based a determination that the virtual object has interacted with a portion of the image; and
an actuation device coupled to the haptic response module, wherein the actuation device is to direct the haptic response module toward the hand.

2. The apparatus of claim 1, further comprising:
a facial tracking sensor coupled to the tracking sensor to track movement of a face relative to the display.

3. The apparatus of claim 1, further comprising:
the display; and
wherein the tracking sensor is a camera disposed on a backside of the display.

4. The apparatus of claim 1, wherein the actuation device is a device selected from a group consisting of: a micro servo, a micro actuator, a galvanometer scanner, an ultrasonic motor, a shape memory alloy actuator, and a micro-electromechanical system (MEMS).

5. The apparatus of claim 1, wherein the haptic response module comprises a blower and a nozzle.

6. The apparatus of claim 1, wherein the haptic response module comprises an array of blowers.

7. The apparatus of claim 1, wherein the haptic response module is to output a compressed mixture of oxygen and nitrogen.

8. The apparatus of claim 1, wherein the haptic response module is to output compressed carbon dioxide.

9. A method, comprising:
detecting, by a computing device, a hand behind a display of the computing device;
displaying, by the computing device, a virtual object via the display based on the detecting of the hand;
determining, by the computing device, that the virtual object has interacted with an image output via the display; and
directing, by the computing device, a stream of air to a position of the hand in response to the determining to convey a haptic response.

10. The method of claim 9, further comprising:
detecting, by the computing device, facial movement relative to the display, wherein the facial movement facilitates displaying the virtual object.

11. The method of claim 9, wherein displaying the virtual object comprises displaying a virtual representation of the hand.

12. The method of claim 9, wherein detecting the hand behind the display comprises detecting a gesture made by the hand.

13. The method of claim 9, wherein directing the stream of air to the position of the hand comprises adjusting a direction of a haptic response module.

14. The method of claim 9, wherein directing the stream of air to the position of the hand comprises directing a stream of air for a predetermined amount of time to the position of the hand.

15. The method of claim 9, wherein directing the stream of air to the position of the hand comprises directing a stream of air with a determined pressure to the position of the hand.

16. The method of claim 9, further comprising:
altering, by the computing device, the image output via the display in response to determining that the virtual representation of the hand has interacted with the image.

17. An article of manufacture comprising a computer readable medium having a plurality of programming instructions stored thereon, wherein the plurality of programming instructions, if executed by a processor, cause a client device to:
display an image and a virtual representation of a hand on a display, wherein the virtual representation of the hand is based on a user's hand disposed behind the display;
determine that the virtual representation of the hand has interacted with the image; and
direct a stream of air to the user's hand disposed behind the display in response to the determination to convey a haptic response.

18. The article of manufacture of claim 17, wherein the plurality of programming instructions, if executed by the processor, further cause the client device to:
detect facial movement of the user relative to the display to direct the stream of air to the hand of the user disposed behind the display.

19. The article of manufacture of claim 17, wherein the plurality of programming instructions, if executed by the processor, cause the client device to:
direct the stream of air to the hand of the user for a determined period of time.

20. The article of manufacture of claim 17, wherein the stream of air has a determined pressure.
